(19) United States
(12) Patent Application Publication
(10) Pub. No.: US 2004/0030701 A1
(43) Pub. Date: Feb. 12, 2004

(54) Method for componentization of electronic document processing

(76) Inventors: Kirstan Vandersluis, Colorado Springs, CO (US); Rohit Mital, Colorado Springs, CO (US)

Correspondence Address: Kirstan A. Vandersluis, 4585 Granby Cir, Colorado Springs, CO, 80919, US

(21) Appl. No.: 09/992,791

(22) Filed: Nov. 19, 2001

Related U.S. Application Data
(60) Provisional application No. 60/249,984, filed on Nov. 20, 2000.

(51) Int. Cl. G06F 7/00

(52) U.S. Cl. 707/10

(57) ABSTRACT

Within a set of computer systems interconnected by a network, the computer systems may be suitably configured to transfer data between one another. An item of data exchanged between these systems can be said to be a “message”. Each message is defined with a format particular to a specific application. Often, the needs of the application demand messages with complex content. A method is presented wherein complex messages can be decomposed for processing by components, whereby each component may interact with a separate server system to process data. Thus, a complex message may be decomposed so that portions of the message may originate from many different systems. Inbound messages can be processed by decomposing them into manageable portions, then sending each portion to an appropriate server.

### CROSS REFERENCE TO RELATED APPLICATIONS

The invention described in this application claims the benefit of the following provisional patent application:

Provisional Patent Application Serial #60/249.984, Filed Nov. 20, 2000, “Method for componentization of electronic document processing”.

The invention described in this application extends the foundation of inventions described in the following application:

patent application Ser. No. 09/264,101, Filed Mar. 8, 1999, “Dynamic, Hierarchical Data Exchange System”

### FIELD OF THE INVENTION

The present invention relates to networked computer systems in which a plurality of interconnected computer systems exchange data.

### BACKGROUND OF THE INVENTION

The present invention relates to computer systems interconnected by a network, suitably configured to transfer data between one another. A computer system connected to the network processes data from a plurality of data sources. A data source can be an input device attached to the computer system, or can be a storage device, memory, database, or other computer system attached either locally or remotely to the computer system via a network. In the network of computers, at any given time, a computer system may assume a specific role, relative to the processing of data. A computer system that sends a request for data to another computer system is said to be a Client system. The computer system that processes requests from other computer systems is said to be a Server system. When a Client sends a request for data to a Server, the Server may retrieve some of the requested data from its local resources, and some of the data from an External source on the network. The Server in this case acts as a Client to an External source, requesting the appropriate data, and the External source acts as a Server. Thus, a computer system on the network may at one time perform the role of a Client, and at another time perform the role of a Server.

Servers on the network are designed to satisfy requests for a particular type of data. For example, a database server may be designed to accept Structured Query Language (SQL) requests from clients. The database server will execute the SQL and return the resulting database data to the requesting client. A Hyper Text Transfer Protocol (HTTP) server (or Web Server) accepts HTTP request from client systems (generally Web Browsers), processes the requests, and returns the resulting Hyper Text Markup Language (HTML) to the client. In an enterprise business environment, such as the Information Processing environment of a large company, a Server system may accept requests for customer account information. A Client may send the request to the Server in an agreed-upon format, and the Server locates the information within its system or connected systems, then returns the customer account information to the Client.

Frequently, the complexity of the data that is the subject of the request requires more than a simple row set format such as that returned by a relational database management system (RDBMS). For example, a request for customer data may include customer information (name, account number, contact information), order history, and for each order, items that were ordered, then for each item, features and characteristics. We refer to the resulting set of data as a “document”. This type of data lends itself to a hierarchical representation such as an Extensible Markup Language (XML) format.

Often, a Client must send data into a Server to be processed. For example, a Client may send a purchase order into the server to be processed. This purchase order may be a complex document with many data components. The complexity of the data again lends itself to a hierarchical data representation such as XML.

The design of Server systems which generate or process complex hierarchical documents is very complex, requiring a great deal of software development. There is a need for a method to reduce the time required to develop systems which process these hierarchical documents. In the current invention, we describe a method, which can be implemented as a computer program, that partitions the required data requirements into components that are conceptually easy to manipulate. The result is a method that drastically reduces the complexity and development time for systems that create and process hierarchical documents.

Computer systems are often required to perform one of two major roles: 1) Producer role: accept requests for a document, retrieve data from many systems to create a hierarchical data document to be returned to a requester, or 2) consumer role: receive a hierarchical data document, then decompose the various elements, storing or processing the various elements in appropriate ways. The present invention provides a method that is very similar for both the producer and consumer roles. Such a method where the Producer and Consumer roles are so similar presents a tremendous advantage when teaching the method to users.

### SUMMARY OF THE INVENTION

Within an electronic document processing system, information sets are retrieved and transformed from one source and/or transformed and sent to a target. Sources and targets include data storage devices, and general processing components which may send and receive data from other sources and targets. The current invention specifies a componentization of the electronic document and its processing requirements into logical layers of processing. Logical component layers are defined to include 1) the logical document level which specifies the logical layout and content of a document (or data message), 2) the data component level which specifies the characteristics of a set of data, including the data format and instructions on how to store or retrieve it, and 3) the physical layer description which specifies the physical location and how to access the physical data. The logical layers are defined to contain common features including parameter passing mechanisms, input and output operations, and general user-defined processing capabilities. The logical layering as described provides distinct advantages in terms of the ability to operate on and reuse data sets, the factoring of processing resources into common and extensible code modules, and the isolation of physical sources and targets from their logical data set representations.

The preferred embodiment of the present invention provides a method for the partitioning the processing of electronic documents into three types of definition files corresponding to the logical processing layers described above: Business Documents (or BizDocuments), BizComponents (or BizComponents), and Business Drivers (or BizDrivers). These definition files are called modules. Each type of file serves a specialized purpose as summarized here:

| | |
|---|---|
| BizDocument | Describes a collection of hierarchical elements, some of |
| | which may be dynamically generated, and some of which |
| | are processing directives to process data, either inbound |
| | to the Server or data within the BizDocument at any |
| | given time. A BizDocument can be parameterized with |
| | simple text substitution or complex hierarchical elements. |
| | Dynamic elements can be references to Biz Components; |
| | the Biz Document then executes the Biz Component and |
| | replaces the reference with the result of the Biz |
| | Component's execution. Parameters passed in by the |
| | Client System allow generation of specific instances of a |
| | document, for example, a customer record with informa- |
| | tion based on a particular customer number. |
| BizComponent | A collection of related data, commonly called a “data |
| | set”. A BizComponent may assume either a producer or |
| | consumer role, or possibly both. In the producer role, |
| | the BizComponent generates a data set dynamically |
| | through a specified process, and returns it to a |
| | referencing BizDocument. In the consumer role, a |
| | BizComponent accepts data input and processes it, |
| | possibly sending it to another processing resource or data |
| | storage system. A BizComponent may take simple |
| | parameters or a complex element structure as input |
| | parameters. A BizComponent has specific responsibilities |
| | of interacting with other processing resource to transfer |
| | data, and conversion to/from XML and the format of the |
| | Server to which it is interacting. Very often a |
| | BizComponent exhibits characteristics of both a |
| | consumer and producer, as it may send a set of data to a |
| | Server and receive a data set in return, which is then |
| | appropriately formatted and returned as the result of the |
| | BizComponent. An example of a BizComponent is one |
| | that encapsulates the retrieval of data from a relational |
| | database. The Biz Component specifies an SQL state |
| | ment and a BizDriver to execute the SQL statement. The |
| | data results are formatted into XML by the Biz |
| | Component, then returned to the referencing Biz |
| | Document. |
| BizDriver | A Biz Driver encapsulates a data source and provides an |
| | interface through which a BizComponent may interact |
| | with a Server. A Biz Driver specifies a data source and |
| | any parameters necessary for the system to connect to the |
| | data source. It manages a connection and/or transaction, |
| | where appropriate, and performs data translation required |
| | by the data source. A Biz Driver provides the ability to |
| | connect to any standard or customized data source. |

Modules provide the ability to view a document or data message as one BizDocument, and zero or more BizComponents and BizDrivers. A designer delegates the responsibility of generating or processing each element or set of elements of the message to one of these modules. The document or data message is said to be composed of elements, which are equivalent to elements in the Extensible Markup Language.

Common Features

BizDocuments, BizComponents, and BizDrivers have common features that facilitate efficient processing and ease of development. The straightforward layering is conceptually simple and natural for developers. The common features between the module types are:

1. Input Parameters. Each module can define a list of input parameters, designating the parameter name, data type, and default value. Each parameter is available through the body of the module for substitution with actual values at run-time. Data types may be defined by the system designer, and may include both scalar and complex types.

2. Input Element. Each module can accept an entire element structure as input. The input structure is a hierarchy of data, generally in the form of XML. Each module has an input area, called the Input Element, which houses the input and makes it available from anywhere in the module at run-time. In addition, an element may be referenced or stored anywhere in the module.

3. Output Element. Each module can have an Output Element. Generally, a module performs some function based on its input and internal definition, then generates output in the form of an Output Element.

4. Processing Capabilities. Any module may specify user-defined processing rules which are carried out by an underlying code component. The processing rules may be specified by a common language defined for the system, or by commonly available languages such as Java, JavaScript, Java Server Pages, or Active Server Pages.

Code Components

Each type of module has an associated code component, which is called upon to execute the contents of a module instance. BizComponent and BizDriver code components are loaded dynamically based on the type of the module.

The BizDocument code component processes BizDocument definition files, which include XML and references to BizComponents and possibly other BizDocuments. This code component processes the document upon request by a Client and returns the results to that client. For each BizComponent reference encountered, it reads the BizComponent file to determine its type, then loads the code component associated with that type of BizComponent, then executes the newly loaded code to process the contents of the BizComponent.

The format of the BizComponent file is completely determined by the BizComponent code component, though generally, the defined formats for input parameters and processing rules must be followed.

A BizComponent may require the services of a BizDriver to provided connectivity to a data source or target. The BizComponent module will reference the BizDriver by name. During processing, the BizDriver file will be opened to determine the BizDriver code component associated with the BizDriver. The code component will be loaded and executed. The code component reads the BizDriver contents to determine the required processing.

Objects and Advantages

The componentization of processing for electronic documents provides several distinct objects and advantages over other methods of processing:

1. Reusable Components—BizComponents can be designed to encapsulate a logical data set and its format in XML or other hierarchical representation. Once designed, a BizComponent can be reused in many different BizDocuments.

2. Data Aggregation—a single logical message can easily be generated from many different physical sources. Once sections of the message are allocated to a data set or BizComponent, the physical data source is independently specified by a BizDriver. Thus, for the normal corporate environment in which data is spread across many systems, a single message can easily create a single logical view of the data, regardless of the number of physical data sources involved.

3. Decomposition—a single logical inbound message can easily be decomposed into portions, each of which can be sent to a different physical data source. Each portion of the message is allocated to a BizComponent for processing, and the physical data source is specified for each by an independent BizDriver.

4. Data source isolation—The BizDriver module type allows definition of logical data sets in the BizComponent without regard to the physical data source or target. In fact, a system can completely change data sources simply by updating BizDrivers. Changing the physical data specification is isolated to the BizDriver, so no BizComponent, BizDocument, or coding changes are required in this case.

5. Factorization of Code Components—code to perform similar operations can be factored into BizComponent code components. Also, common code that operates on pure XML data, such as a Join operation or conditional processing operation, can be placed at the BizDocument level. BizComponents can translate any type of data to XML and provide this data to the BizDocument, at which point any XML-based operation can be performed.

6. Extensibility—new BizComponent or BizDriver types can be added to the system dynamically. Following the template libraries and code header files, new code components can be designed and added without rebuilding the base system. The new code components are loaded when the designated BizComponent or BizDriver module is loaded. This allows any party to extend the system to suit customized purposes.

7. Data-rich workflow operations—a programming language can be implemented within the BizDocument which can use BizComponents as data-oriented operations. The BizDocument thus defines a workflow supporting applications such as order validation prior to storage and processing. Data synchronization is also supported as a BizDocument may contain one or more BizComponents that read data from one format, and another set of BizComponents that convert and store the data to other data sources.

### DESCRIPTION OF DRAWINGS

FIG. 1, Structure of Components, shows how a client requests a BizDocument, and how the processing responsibilities are divided between the BizDocument, BizComponents, and BizDrivers.

FIG. 2, Operation, is a flowchart of a system implementing the described method.

FIG. 3, XML Purchase Order List, shows an example of a message in XML format.

FIG. 4, Dynamic Message Creation, shows the generation process of the XML Purchase Order List, and the allocation to a BizDocument, two BizComponents, and two BizDrivers.

FIG. 5, Purchase Order List BizDocument, is an example BizDocument in XML format showing the portions of the message allocated to the BizDocument, and the reference to a BizComponent to which other message portions are allocated.

FIG. 6, Purchase Order Retrieval BizComponent, is an example BizComponent which has the responsibility to retrieve customer information for an order using a BizDriver and format it into XML to be returned to the calling BizDocument.

FIG. 7, Customer Database BizDriver, is an example BizDriver that provides connectivity to a database containing customer profile information related to purchase orders.

FIG. 8, Order Item Retrieval BizComponent, is an example BizComponent which has the responsibility to retrieve detailed order item information for an order using a BizDriver and format it into XML to be returned to the calling BizComponent or BizDocument.

FIG. 9, Order Detail BizDriver, is an example BizDriver that provides connectivity to a database containing order detail information.

FIG. 10, Dynamic Message Processing, shows the processing of an inbound XML Purchase Order List, and the allocation of processing to a BizDocument, two BizComponents, and two BizDrivers.

FIG. 11, Dynamic Message Processing BizDocument, is an example BizDocument that processes an inbound XML Purchase Order.

FIG. 12 (12a and 12b), Purchase Order Processing BizComponent, is an example BizComponent which has the responsibility to process inbound customer information for an order using a BizDriver and changing the format from the inbound XML passed from the BizDocument into a format appropriate for the destination database.

FIG. 13, Order Item Processing BizComponent, is an example BizComponent which has the responsibility to process inbound order detail information for an order using a BizDriver and changing the format from the inbound XML passed from a BizComponent into a format appropriate for the destination database.

FIG. 14, New OrderID BizComponent, shows a BizComponent that is able to create a unique Order ID.

### DETAILED DESCRIPTION OF THE INVENTION

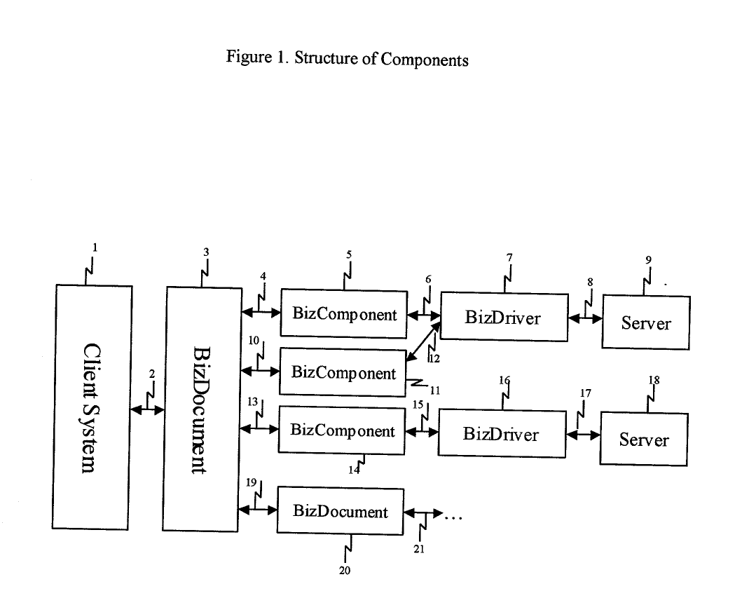

FIG. 1, Structure of Components, is a block diagram showing the relationships between a Client system, BizDocuments, BizComponents, BizDrivers, and Servers. The method to generate or process messages requires a designer to partition processing responsibilities among the BizDocument, BizComponent, and BizDrivers, while maintaining the logical layering described previously. The designer will allocate static or invariant sections of the message generation or processing to the BizDocument, and allocate dynamic generation or processing to BizComponents. BizComponents may delegate physical connectivity processing to BizDrivers. The general relationships are as follows: A Client System 1 that desires an instance of a message sends a request for that message, with any required parameters over interface 2 to a BizDocument 3. A BizDocument is an XML file with possibly static contents intermixed with references to BizComponents. For example, the BizDocument 3 references BizComponent 5 over interface 4, which interacts with Server 9 by sending a request over interface 6 to BizDriver 7, which establishes and maintains a session and/or connection with Server 9 over interface 8.

BizComponents may use the same BizDriver. For example, BizDocument 3 sends a request over interface 10 to BizComponent 11, which sends requests over interface 12 to BizDriver 7, thus sharing session and transaction states with BizComponent 5.

BizDocuments may call any number of BizComponents, thereby including many (possibly related) data sets in the message, or decomposing inbound data into many data sets to be sent to many Servers. As an example, BizDocument 3 sends a request over interface 13 to BizComponent 14, which sends a requests to BizDriver 16 over interface 15. BizDriver 16, in turn, interacts directly over interface 17 to Server 18.

BizDocuments can also send or receive data to/from other BizDocuments. For example, BizDocument 3 sends a request over interface 19 to BizDocument 20, which interacts with possibly many other BizComponents and/or BizDocuments as shown generically over interface 21.

Note that BizDriver 7 and BizDriver 16 maintain a session with Server 9 and Server 18, respectively, and session management techniques are applied to maintain this session across BizComponent requests as well as across BizDocument requests. Also, the BizDocument may be designated to run within a transaction, in which case BizDriver 7 and BizDriver 16 establish and maintain transactions on Server 9 and Server 18, respectively.

BizComponents may also send requests to other BizComponents.

In addition, BizDocuments, BizComponents, and BizDrivers are cached for rapid execution on subsequent requests.

It is important to note that from a Client System perspective, it interfaces to a single BizDocument, regardless of the complexity of the message or the number of Servers involved in the generation or processing of the message.

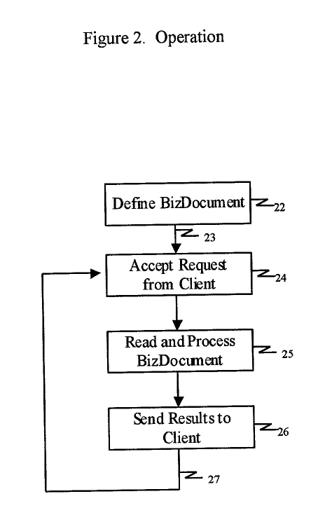

FIG. 2 shows a flowchart of the preferred embodiment of the present invention. A designer creates a BizDocument and related BizComponents and BizDrivers in the first step, “Define BizDocument” 22. A computer-implemented BizDocument Server receives the BizDocument and related BizComponents and BizDrivers over interface 23. The BizDocument Server is then configured to accept requests from Clients 24. These requests include the name of a BizDocument and any parameters, including input data for the Input Element which may be processed by the BizDocument. Upon receipt of a request from a Client, the BizDocument Server reads the BizDocument into an attached memory, applies input parameters, and stores the Input Element, if present, then processes the BizDocument 25. The processing of the BizDocument is discussed later, however, it is important to note that the BizDocument in the attached memory is altered in the process, and this altered version is called the BizDocument instance. The BizDocument instance is then returned as the result of the process 26, and the BizDocument Server returns to a state where it can again accept a request from a client 24.

BizDocument Processing

Processing of the BizDocument proceeds by visiting each element executing if appropriate in a manner described by patent application Ser. No. 09/264,101, Filed Mar. 8, 1999, “Dynamic, Hierarchical Data Exchange System”. This includes performing substitutions for reference strings of the form “% % <reference>”, where <reference> is text referencing an element or attribute in the document as a path (as in the XPath specification), or it may reference an input parameter by name. The reference string is replaced by the value at the element or attribute specified, or the value passed in as the parameter. Processing also includes executing the element if it is executable and conforms to the format of a specified processing operation. In addition to mechanisms described in “Dynamic, Hierarchical Data Exchange System”, if the element visited is a BizComponent reference, BizComponent processing occurs.

To process a BizComponent, the BizComponent definition is retrieved from a file or other processing resource. The definition indicates what BizComponent Type the BizComponent conforms to. This indication provides the information necessary to load a code module which processes BizComponents of that type, and this code module is loaded if it has not already been loaded. The code module conforms to an interface that the BizDocument Server expects. The dynamic loading characteristics of the BizComponent code module can be implemented by a variety of techniques, such as a Java interface implemented by a loadable classes, or Dynamic Link Library implementing a class that inherits from a BizComponent base class which defines the interface. Technical details of dynamically loaded code modules is not described here as it is obvious to one skilled in the art.

Every BizComponent code module implements certain operations that the BizDocument Server is aware of. These operations include at a minimum, loading the BizComponent definition, setting input parameters, setting an Input Element, executing the BizComponent, and retrieving the results of the BizComponent execution. The general steps performed by the BizDocument Server on the BizComponent reference are:

1. Load the BizComponent definition

2. Load the BizComponent code module

3. Direct the BizComponent code module to load the elements of the BizComponent definition into internal structures. Some of these elements are standard across all BizComponents, such as parameter definition elements, and others are specific to a particular BizComponent Type.

4. Pass parameters and the Input Element into the BizComponent

5. Direct the BizComponent to execute itself

6. Retrieve the element set results of the BizComponent, copying these results into the BizDocument at the location of the original BizComponent reference.

Importantly, the element set results may contain other dynamic elements, such as references to other BizComponents, BizDocuments, and executable elements. Execution of the BizDocument will proceed with the next unexecuted element, which will be the first element in the element result set.

Some BizComponent Types rely on BizDrivers to supply connectivity to Servers and transaction management. In these cases, the BizDriver definition is loaded by the BizComponent code module in a process similar to that of the BizDocument Server loading BizComponent code modules. The BizDriver definition specifies a BizDriver Type, which indicates a code module to dynamically load to process the BizDriver.

As an example, a BizComponent Type of “SQL” processes SQL statements to retrieve and store data into and out of an RDBMS. A particular SQL BizComponent will specify a BizDriver to use as the intermediate component which will interact directly to the RDBMS. The SQL BizComponent code module expects to find a reference to a BizDriver in the BizComponent. This BizDriver reference is used to load the actual BizDriver definition, which specifies a BizDriver Type, such as ODBC, ADO, JDBC, or DAO. A BizDriver code component is then loaded to process that specific type of BizDriver. As with BizComponents code modules, BizDriver code modules conform to an interface and are dynamically loaded and controlled by the calling context. So the SQL BizComponent code module will load the appropriate BizDriver code module into memory, and control that code module via an interface that it has defined. The SQL BizDriver code modules have interfaces to open connections, manage transactions, execute SQL statements, and manage result sets.

The BizDocument Server introduced earlier must perform certain administrative tasks. These include receiving the request as mentioned, loading the BizDocument, sending input parameters and the Input Element into the BizDocument, as appropriate, executing the BizDocument, retrieving the results, and returning the results to the Client.

Operation of the Inventions

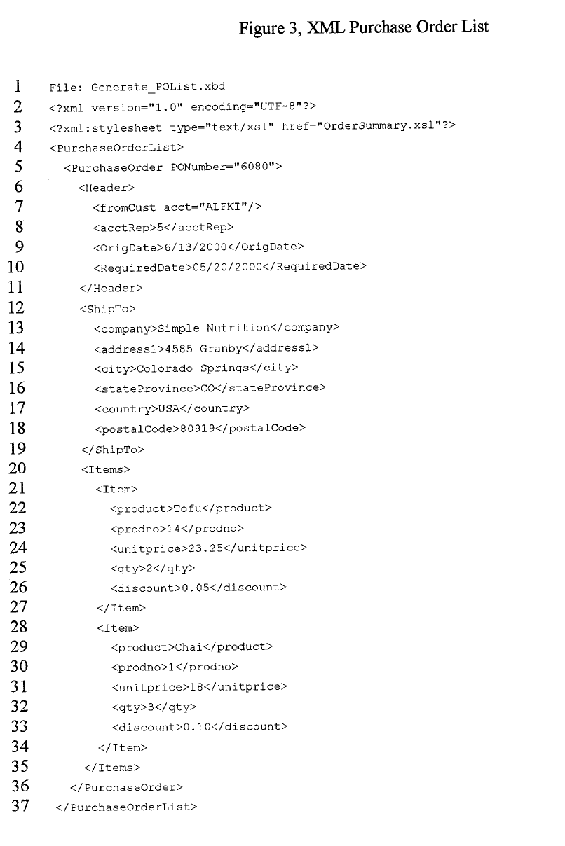

FIG. 3, XML Purchase Order List, is an example document or data message that could be used in an electronic commerce application. In the preferred embodiment of the current invention, this message may be decomposed into modules for processing. In a complex example, it could be the case that the information for this message must come from multiple systems within an enterprise. It is this case that this example demonstrates.

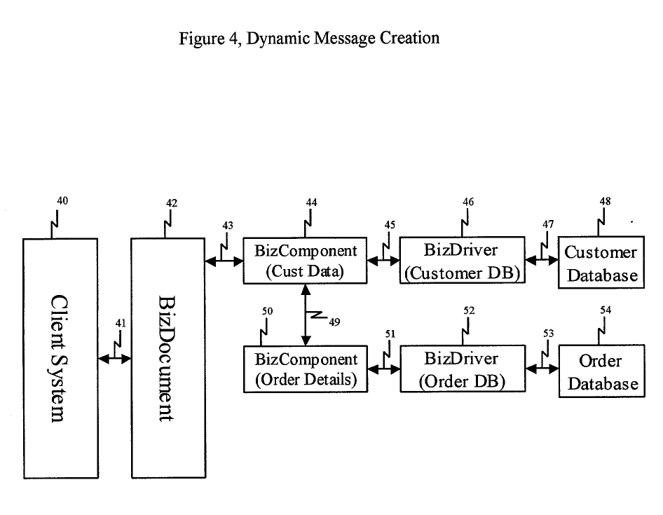

FIG. 4, Dynamic Message Creation, is an example of how the message may be decomposed. The message can be accessed from the Client System 40 by sending a request over interface 42 to the BizDocument 42. Note that a BizDocument Server is assumed to be receiving the request and managing the execution of the BizDocument. The BizDocument identified by the Client is loaded, and input parameters and the Input Element is stored in the BizDocument. The BizDocument references a BizComponent 44 via interface 43 to generate the customer level data for the order (Header and ShipTo information). This BizComponent uses BizDriver 46 via interface 45 to interact directly to the Customer Database 48 via interface 47. Of the data retrieved through these interfaces, one of the elements is an OrderID. This OrderID is used by BizComponent 44 to call BizComponent 50 via interface 49, which will generate the order details for the order. BizComponent 50 uses interface 51 to access BizDriver 52 which connects directly to Order Database 54 via interface 53.

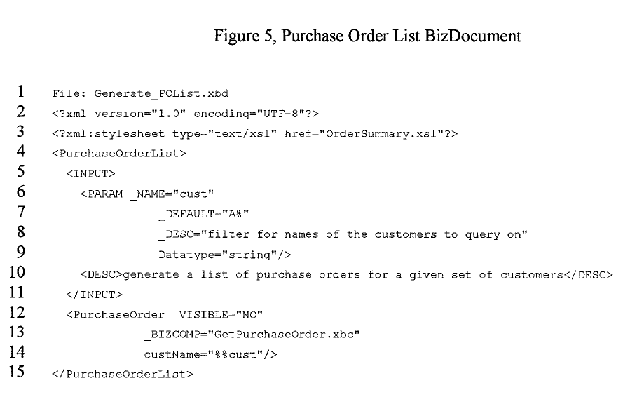

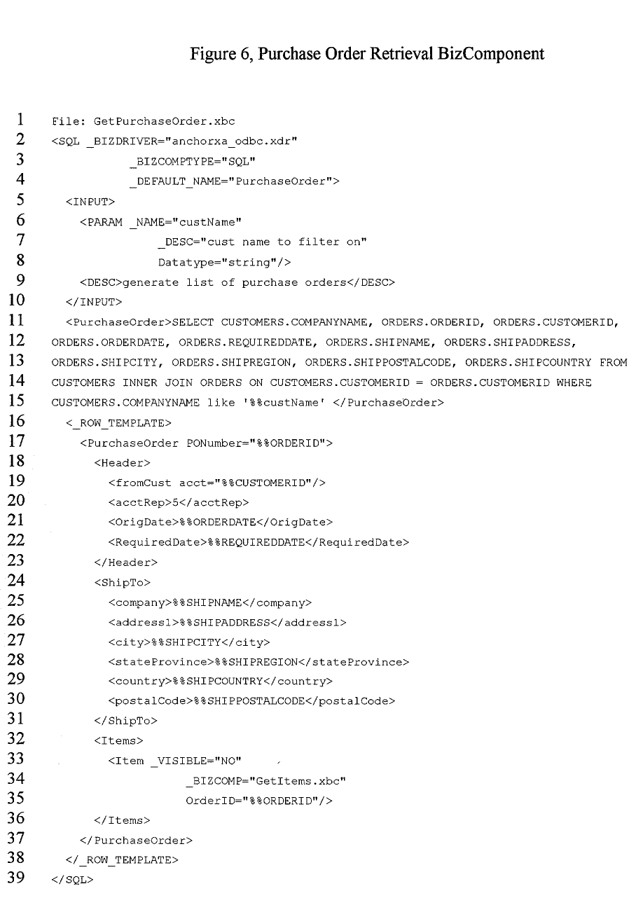

The BizDocument definition is shown in FIG. 5, Purchase Order List BizDocument. Some of the elements (lines 2, 3, 4, 15) are static and are simply passed into the output element set of the BizDocument, to be returned unchanged to the Client. The Input element (lines 5-11) defines parameters, specifically a parameter called “cust” on line 6. The Client supplies a value for this parameter. This parameter is then references at line 14 with the notation “% % cust”. This reference string is replaced by the actual value passed in by the client. Lines 12-14 constitute a BizComponent reference, similar to method calls in a procedural language. It is this element that effects processing the BizComponent, the definition of which is in FIG. 6.

FIG. 6, Purchase Order Retrieval BizComponent, is a typical SQL BizComponent. Line 3 indicates that this BizComponent Type is “SQL”. The BizDocument Server associates this with a code module (SQL BizComponent Code Module) and loads the module to process this BizComponent. Line 6 defines the sole input parameter for this BizComponent, “custName”; the BizDocument Server sets this value at line 14 in FIG. 5 as discussed previously. The remainder of the file is content that is specifically processed by the SQL BizComponent Code Module. Lines 11-15 define an SQL statement to be processed. Note the reference string “% % custName” on line 15. The actual value of the custName parameter replaces the reference string, effectively customizing this BizComponent based on the needs of the calling BizDocument. This SQL statement (after applying reference string substitutions) will be sent to a BizDriver as specified in line 2. The Row Template in lines 16-38 defines a template which is replicated for each row returned by the BizDriver (and ultimately the database). Notice reference strings in this section. They reference actual values from the returned result set from the BizDriver. Lines 33-35 is a reference to another BizComponent, one which will generate a list of Item elements for the order. Line 35 indicates that an element from the first data set (ORDERID) is sent as a parameter to the second BizComponent, effectively chaining a request into another BizComponent, and possibly another data source.

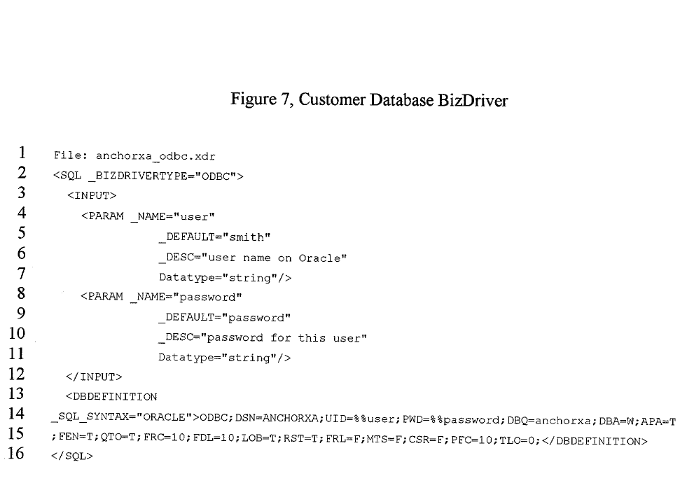

FIG. 7, Customer Database BizDriver, shows the BizDriver definition used by the BizComponent in FIG. 6. Line 1 indicates the BizDriver Type, which is used to associate a code module to be dynamically loaded. Lines 2-11 define the list of input parameters in the module, one for a user name (lines 3-6) and one for a password (lines 7-10). The remainder of the file contains data which the code module will deal with, in this case a connect string used to manage the connection to the physical data source. Notice that reference strings “% % user” and “% % password” appear at line 13 as part of the connect string, therefore directing the characteristics of the database connection. These reference strings are replaced with actual values passed in to the BizDriver.

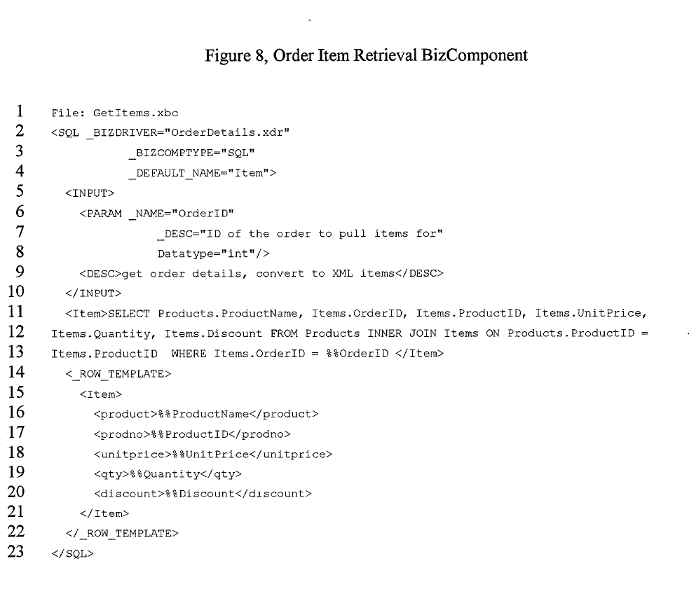

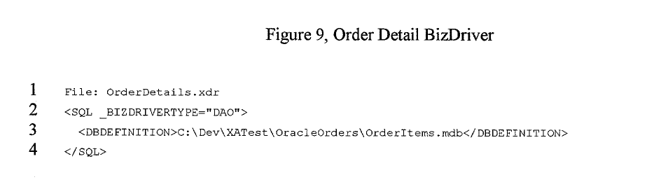

FIG. 8, Order Item Retrieval BizComponent is the definition of the BizComponent which will generate Item elements for the message. This BizComponent is called from Lines 33-35 of FIG. 6. Line 2 indicates the BizComponent Type is SQL, therefore the SQL BizCompenent Code Module is used to process this module. Since that code module is already loaded, the loaded code will be used without the need to reload a code module. Line 1 indicates that this BizComponent uses a BizDriver “OrderDetails.xdr” (included as FIG. 9, Order Detail BizDriver for reference) to connect to a different database and execute the contained SQL query in lines 10-12 (after reference string substitution). Execution proceeds in the same manner as described for FIG. 6.

It is important to recognize that the BizDocument Server executes elements in order. After executing the BizComponent in FIG. 6, the element set result is copied into the BizDocument. The newly created elements will be executed in depth-first order. Since the BizComponent in FIG. 6 includes references to the BizCompenent in FIG. 8 within its Row Template, those elements will be executed when visited by the BizDocument Server. The result is a message with the format of FIG. 3, with element sections generated from multiple data sources.

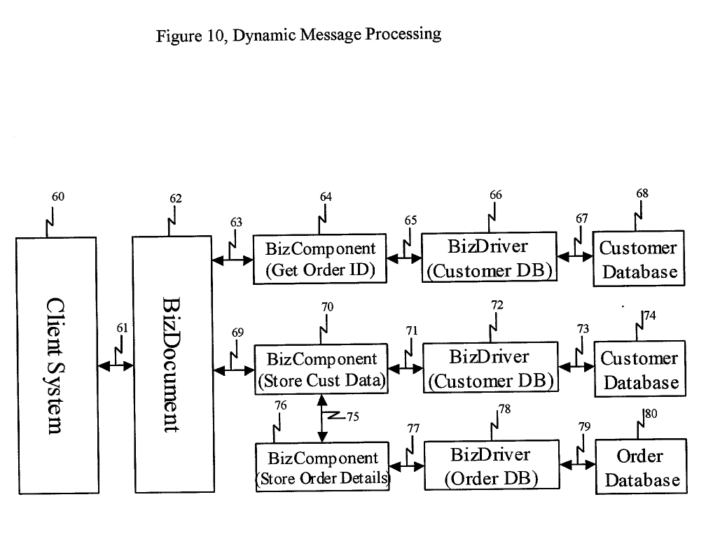

Returning to FIG. 3, XML Purchase Order List, it is possible to define components that process an inbound message of this format. FIG. 10, Dynamic Message Processing, shows Client System 60 sending a message with the format of FIG. 3 over interface 61 to BizDocument 62. BizDocument 62 uses interface 63 to send a request to BizComponent 64 for the purposes of creating a new Order ID to associate with the inbound data. BizComponent 64 interfaces to BizDriver 66 via interface 65 which connects to the Customer Database 68 via interface 67, thereby providing database connectivity sufficient to create a unique ID on the database. Once BizComponent 64 executes, the results are returned to BizDocument 62, which may then pass the new Order ID to other processing components. BizDocument 62 then uses interface 69 to BizComponent 70 in order to store the customer level information of the order (Header and ShipTo elements). BizComponent 70 sends a request to store data via interface 71 to BizDriver 72, which stores the data via interface 73 to the Customer Database 74. BizComponent 70, after causing the Header and ShipTo elements to be stored, then uses BizComponent 76 via interface 75 to store the remaining data, the list of Item elements.

BizComponent 76 uses interface 77 to access BizDriver 78, which stores the actual order details (Item elements) to the Order Database 80.

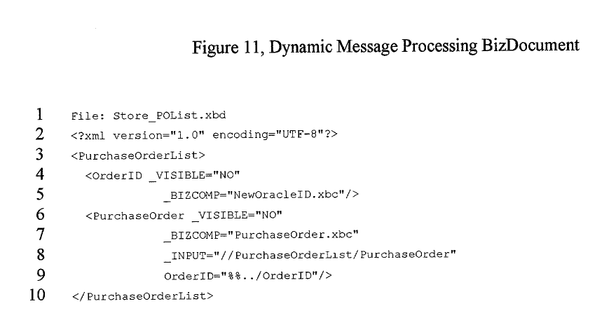

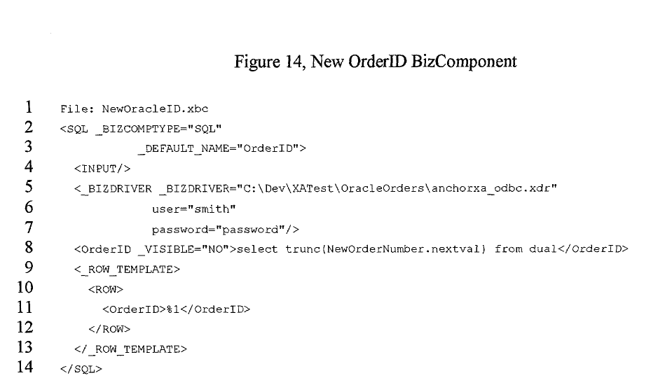

FIG. 11, Dynamic Message Processing BizDocument, shows the BizDocument which will process the inbound message with the format shown in FIG. 3. The BizDocument Server will load the BizDocument, and store the inbound message from the Client into the BizDocument's Input Element, making it available for processing. Lines 4-5 show a reference to a BizComponent that will generate a new Order ID. When the BizDocument Server visits this element, it loads the BizComponent in FIG. 14, New OrderID BizComponent.

FIG. 14, New OrderID BizComponent, indicates a BizComponent Type of “SQL”. As in previous examples, the BizDocument Server loads the appropriate code module for this type, which is used to process this file. Lines 5-7 indicate the BizDriver to use to execute the SQL in line 8. The result is formatted by the Row Template in lines 9-13. As shown, the result set from the BizDriver is referenced in line 11 with “% 1”, indicating the first column replaces this reference string.

FIG. 11, lines 6-9 show a reference to a BizComponent which process the PurchaseOrder element of the message (lines 4-36 of FIG. 3). Upon visiting this element, the BizDocument Server loads the referenced BizComponent in preparation for processing, and loads the associated code component as usual. Notice the _INPUT attribute at line 8 which begins with a notation indicating a path into the Input Element of the BizDocument. The attribute _INPUT=“//PurchaseOrderList/PurchaseOrder” causes the element within the Input Element at path location/PurchaseOrderList/PurchaseOrder to be moved to the Input Element of the BizComponent being called. The reference string at line 9, “% % . . . /OrderID” causes the OrderID value from the BizComponent results from lines 4-5 to be used as a parameter into this BizComponent.

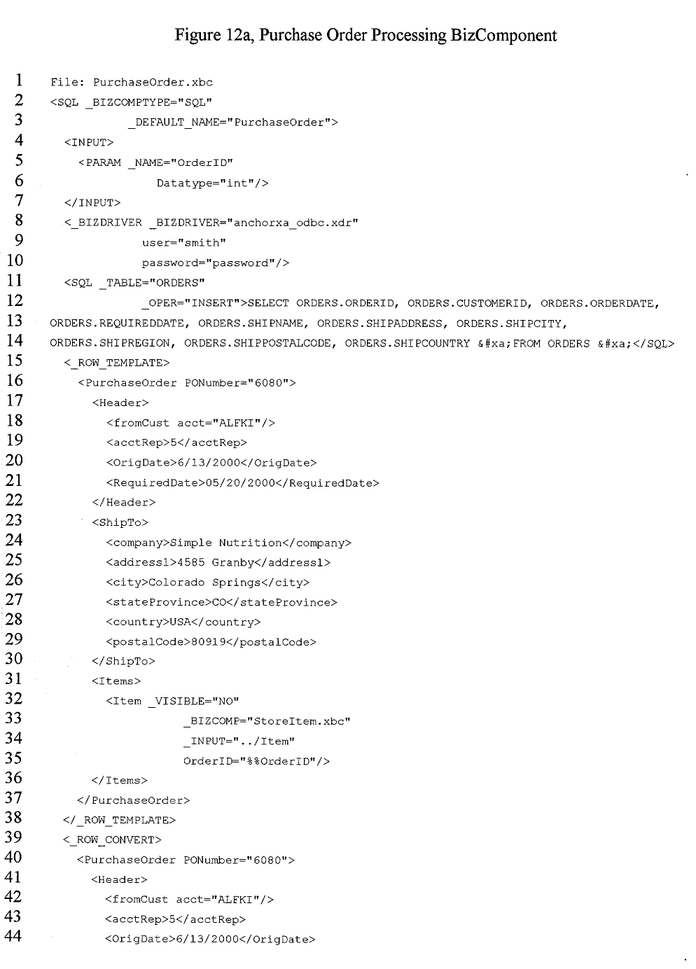

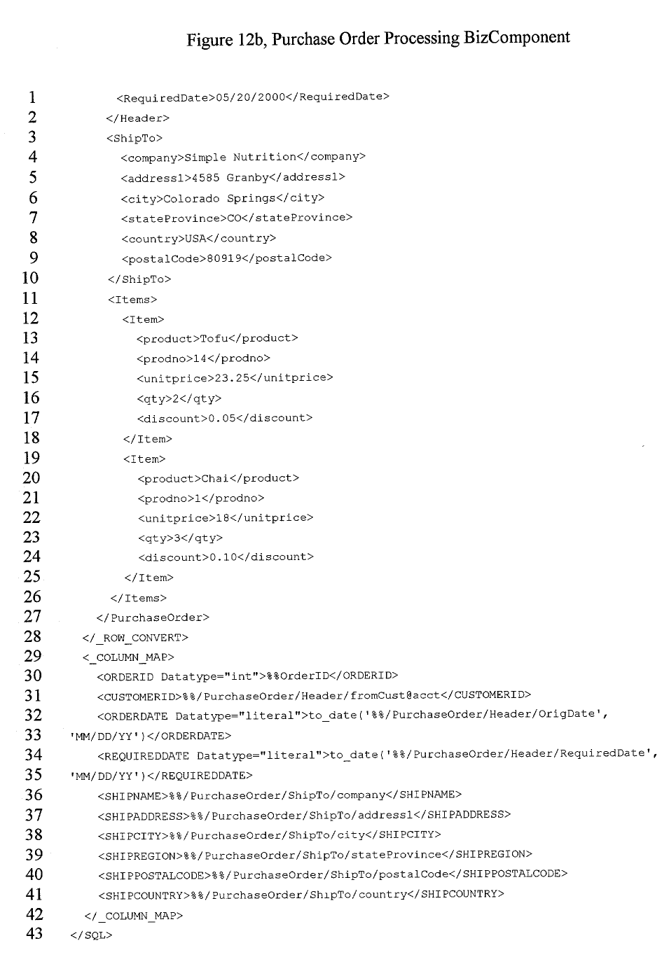

FIGS. 12a and 12b, Purchase Order Processing BizComponent, show the BizComponent definition which processes the PurchaseOrder element. As with other BizComponents, the BizDocument Server reads the BizComponent Type at line 2 and loads the appropriate code component, if it is not already loaded. The BizDriver reference at lines 8-10 indicate the BizDriver this BizComponent will uses, and also passes appropriate parameters to the BizDriver. The BizComponent contents at lines 15-44 of FIG. 12a and lines 1-42 of FIG. 12b are processed by the SQL BizComponent Code Module. Particular content of this BizComponent directs the code component to format an Insert statement (line 12,_OPER=“INSERT”), expecting a set of inbound elements with the format as shown in the Row Template, lines 15-38, extracting data for the column inserts as specified by the Column Map element in FIG. 12b, lines 29-42. The Row Template also dictates a “merge” operation of each inbound element with the Row Template, the result of which becomes an element of the output set of this BizComponent. This merge operation injects the BizComponent reference of FIG. 12a, lines 32-35 into the result set, where it will later be processed by the BizDocument Server as part of its depth-first processing sequence.

The above-mentioned merge operation is a general feature available to all BizComponents, and provides a mechanism for an inbound BizComponent to process elements within its Input Element that it knows how to process, and effectively defer or delegate processing of other elements to other BizComponents.

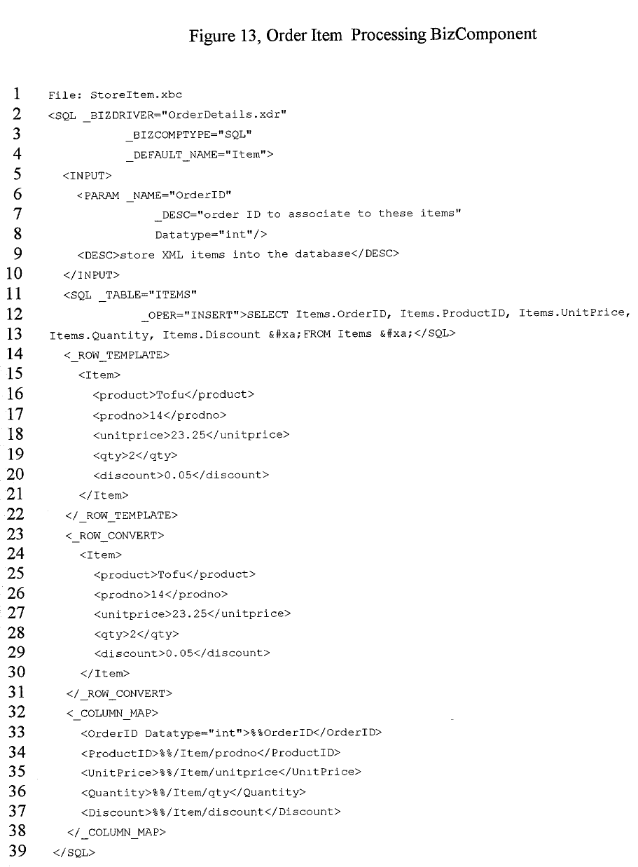

FIG. 13, Order Item Processing BizComponent, shows the definition of the BizComponent referenced from FIG. 12a, lines 32-35, which will store the order details (Item elements) into a separate database, as indicated by the BizDriver reference in line 2. As before, the BizDocument Server will load the code module as indicated by line 3 to process this BizComponent Type, and in particular will process the contents of this BizComponent, which will cause all Item elements in the Input Element to be stored to a database specified by BizDriver OrderDetails.xdr (line 2).

The preferred embodiment of the current invention recognizes the many similarities between BizDocuments, BizComponents, and BizDrivers, such as Input Parameter definitions, reference string substitutions, and element processing, and implements this processing in common components. It is left to dynamically loaded BizComponent and BizDriver code modules to implement specific operations for various BizCompoent Types and BizDriver Types.

While the above descriptions contain many specificities, these should not be construed as limitations on the scope of the invention, but rather as an exemplification of one preferred embodiment thereof. Many other variations are possible.

Accordingly, the scope of the invention should be determined not by the embodiment illustrated, but by the appended claims and their legal equivalents.

Summary

The examples shown for the preferred embodiment demonstrate Server systems that are relational databases. The current invention, however, is not at all limited to relational databases. Rather, the delegation of message elements can be to map parameters onto method calls on objects in the CORBA, Java Beans, or Enterprise Java Beans sense, or to parameters on any executable system. Thus, elements can be mapped to virtually any computer-processed data. This is important, since on the Consumer Role in particular, elements are often sent to processors for additional processing, often causing crucial effects within the processing system.

In summary, the Consumer Role can partition the hierarchical document into components in such a way so as to send some portions of the document to databases, and other portions to processing components.

Likewise, for the Producer Role, the current invention includes the ability to not only retrieve data from databases, but to also retrieve data from other, more generalized processing components.

Note also that in the preferred embodiment of the current invention, partitioning occurs on a sample XML file representing the format of the XML to produce or consume. The current invention is not limited to partitioning to a sample XML file. Rather, other representations of the XML structure may be used, such as a DTD or XML Schema representation.

What is claimed:

1. A method for partitioning processing responsibilities for the processing or generation of data messages into components comprising the computer-implemented steps of:
a. Define a BizDocument which defines a data message;
b. Provide for the ability for Client systems to request a specific BizDocument;
c. Upon receipt of a request for a BizDocument, read the BizDocument into an attached memory, perform processing on each element within the BizDocument according to a predefined computer language;
d. Send the resulting contents of the attached memory to the requesting Client system.

2. The method of claim 1 wherein the method further comprises the steps of providing the capability to define data sets called BizComponents associated to one or more elements of a message, a BizComponent having a definition that is stored in a separate file or module, or generated by some other process, and the capability of processing a BizComponent during the processing of elements within the BizDocument.

3. The method of claim 2 wherein a BizComponent may include the definition of parameters for which the calling BizDocument or Client will provide actual values.

4. The method of claim 3 wherein a BizComponent may accept a set of elements as input and may provide a set of elements as output.

5. The method of claim 4 wherein a BizComponent may interact with a Server system, or other BizComponent, or other BizDocument to transfer data to or from that Server system.

6. The method of claim 5 wherein a BizComponent may transform data between the required format of the Server system with which it interacts, and the desired format of a message;

7. The method of claim 6 wherein a BizComponent may contain processing instructions which are processed according to a predefined computer language.

8. The method of claim 7 wherein a BizComponent may be considered to belong to a class of BizComponents, and a computer program or code module designed to process BizComponents in that class may be loaded to process the BizComponent.

9. The method of claim 8 wherein the method further comprises the steps of providing the capability for a BizComponent to access a Server system through an intermediate entity called a BizDriver, a BizDriver having a definition stored in a separate file or module, or generated by some other process.

10. The method of claim 9 wherein a BizDriver may include the definition of parameters for which the calling BizComponent will provide actual values.

11. The method of claim 10 wherein a BizDriver may accept a set of elements as input and may provide a set of elements as output.

12. The method of claim 11 wherein a BizDriver may interact with a Server system, to transfer data to or from that Server system.

13. The method of claim 12 wherein a BizDriver may contain processing instructions which are processed according to a predefined computer language.

14. The method of claim 13 wherein a BizDriver may be considered to belong to a class of BizDrivers, and a computer program or code module designed to process BizDrivers in that class may be loaded to process the BizComponent.

15. The method of claim 14 wherein the format of a BizDocument, BizComponent, and BizDriver may be Extensible Markup Language (XML).

16. The method of claim 15 wherein a BizDocument may include the definition of parameters for which the calling Client will provide actual values.

17. The method of claim 16 wherein a BizDocument may accept a set of elements as input and may provide a set of elements as output.

18. The method of claim 17 wherein a BizDocument may contain processing instructions which are processed according to a predefined computer language.
